(19) United States
(12) Patent Application Publication
(10) Pub. No.: US 2007/0034111 A1
(43) Pub. Date: Feb. 15, 2007

(54) Modular vehicle roof platform system

(76) Inventor: Arbab Khan, Jamaica, NY (US)

Correspondence Address: DILWORTH & BARRESE, LLP, 333 EARLE OVINGTON BLVD., UNIONDALE, NY, 11553, US

(21) Appl. No.: 11/500,256

(22) Filed: Aug. 7, 2006

Related U.S. Application Data
(60) Provisional application No. 60/707,829, filed on Aug. 12, 2005.

(51) Int. Cl. B60T 17/22

(52) U.S. Cl. 105/463.1

(57) ABSTRACT

The present invention provided a modular roof platform system having a plurality of modular roof platforms. Each modular roof platform includes a structural body having a main body and a plurality of legs, the legs extended from the main body along a circumferential direction with a predetermined tilt angle, a brace plate attached to the structural body, and a plurality of support feet rotatalby coupled to an end of each legs of structural body. The brace plate is rotatably coupled to one side of the structural body or fixed on the structural body for preventing lateral shift of an item from the structural body.

### PRIORITY

This application claims priority to provisional application entitled “Modular Vehicle Roof Platform” filed in the United States Patent and Trademark Office on Aug. 12, 2005, and assigned Ser. No. 60/707,829, the contents of which are incorporated herein by reference.

### BACKGROUND OF THE INVENTION

1. Field of the Invention

The present disclosure relates generally to a modular vehicle roof platform system, and more particularly to a kit of modular individual support platforms restrained from moving on a substantially flat surface of a vehicle to hold and support objects for transport.

2. Description of the Related Art

Generally, it is not easy for consumers to use their own vehicles for transporting large items. More particularly, even though consumers own a vehicle, there is no way to bring a large item home unless users pay to have it delivered or tie it to their car, which may cause scratches and dents. Therefore, any consumer who shops at furniture stores, home improvement centers or any other places needs a means to safely transport the purchased items so that the consumer is free to purchase any large items.

### SUMMARY OF THE INVENTION

The present invention solves at least the foregoing problems and provides a modular vehicle roof platform system and a kit of modular individual support platforms restrained from moving on a substantially flat surface of a vehicle to hold and support objects for transport.

It is aspect of the present invention to provide a modular vehicle roof platform system as a safe means of transporting a large item or object on the roof of any type of vehicle.

It is another aspect of the present invention to provide such a roof platform system that will safely help consumers transport their large items without damages to the vehicle or without incurring a delivery charge.

According to an aspect of the present invention, there is provided a modular roof platform system having a plurality of modular roof platforms. Each modular roof platform includes a structural body having a main body and a plurality of legs, the legs extended from the main body along a circumferential direction with a predetermined tilt angle, a brace plate attached to the structural body, and a plurality of support feet rotatalby coupled to an end of each legs of structural body. The brace plate is rotatably coupled to one side of the structural body or fixed on the structural body for preventing lateral shift of an item from the structural body.

According to another aspect of the present invention, there is provided a modular roof platform system having a plurality of modular roof platforms. Each modular roof platform includes a main body having at least three structure beams and a top base, the top base mounted on an upper side of the structure beams, a lateral supporting element attached to the main body, a bottom base having suction cup insertion holes, the bottom base enclosing the structure beams, and a plurality of suction cups detachably attached on an underside of each structure beams of the main body.

According to still another aspect of the present invention, there is provided a modular roof platform system having a plurality of modular roof platforms. Each modular roof platform a main body having first and second openings, and a slide bar shaft, a lateral supporting element attached to the main body, a top base enclosing the first openings of the main body, a bottom base enclosing the second openings of the main body, and a protective cap fixed to the second openings of the main body.

The lateral supporting element may be fixed to the main body or a slide bar slidably attached to side surfaces of the structure beams.

### BRIEF DESCRIPTION OF THE DRAWINGS

The above and other objects, features and advantages of the present invention will become more apparent from the following detail detailed description when taken in conjunction with the accompanying drawings in which:

FIG. 1 illustrates a perspective view of inner structure of a platform without outer skin structure with the slide bar in place according to the present invention;

FIG. 2 illustrates a bottom view of a base shown in FIG. 1;

FIG. 3 illustrates a perspective and side view of a slide bar according to the present invention;

FIG. 4 illustrates a perspective view of outer skin structure of a platform according to the present invention;

FIG. 5 illustrates a side view of a platform of FIG. 4;

FIG. 6 illustrates a side view of a platform with slide bar raised of FIG. 4;

FIG. 7 illustrates a kit for final product according to the present invention;

FIG. 8 illustrates a perspective view depicting the modular vehicle roof platforms located on a roof of a vehicle;

FIG. 9 illustrates a perspective view of a platform according to the present invention;

FIG. 10 illustrates a top view of a platform of FIG. 9;

FIG. 11 illustrates a side view of a platform of FIG. 9;

FIG. 12 illustrates a bottom view of a platform of FIG. 9;

FIG. 13 illustrates an exploded view of a platform of FIG. 9;

FIG. 14 illustrates a perspective view of a platform where the brace plate is opened;

FIG. 15 illustrates a perspective view of a platform according to the present invention; and

FIG. 16 illustrates an exploded view of a platform of FIG. 15.

### DETAILED DESCRIPTION OF THE PREFERRED EMBODIMENTS

A preferred embodiment of the present invention will be described herein below with reference to the accompanying drawings. In the following description, well-known functions or constructions are not described in detail since they are clearly understood in the art upon consideration of the present disclosure.

Consumers can use their own vehicles to transport a large volume item by using the roof platform of the present invention, regardless of the type of the vehicle. The unique features of the present invention are cost efficient and can be used over and over. Thus, one small investment will save consumers hundreds in delivery charges. Also, the platforms of the present invention can be useful in many ways to rest or store large items on the roof of the vehicle to prevent damage to the surface or paint finish of the vehicle.

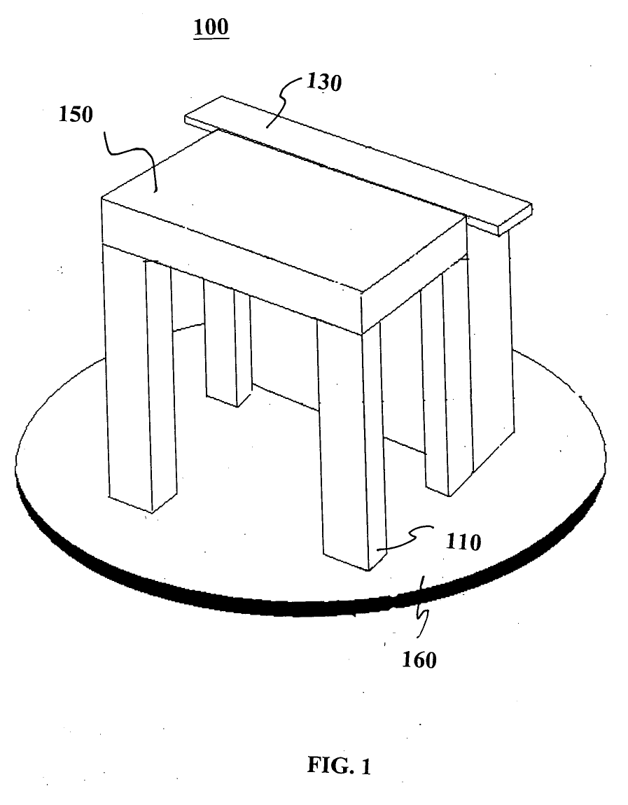

FIG. 1 is a perspective view of the inner structure of the platform 100 in which a slide bar 130 is in place.

As shown in FIG. 1, the modular roof platform according to the present invention includes a main body 110, a bottom base 160 and a slide bar 130.

The main body 110 according to the present invention has a substantially rectangular configuration with four corners. The main body 110 includes four structure beams 140 at a desired length having a rectangular cross-sectional shape, in a preferred embodiment. Other shapes, including a solid block of cylindrical, cubic, etc., are contemplated. Each corner of a top base 150 is mounted on an upper side of each structure beams 140, respectively. Preferably, the top base 150 and the structure beams 140 may be integrally manufactured by a plastic molding method.

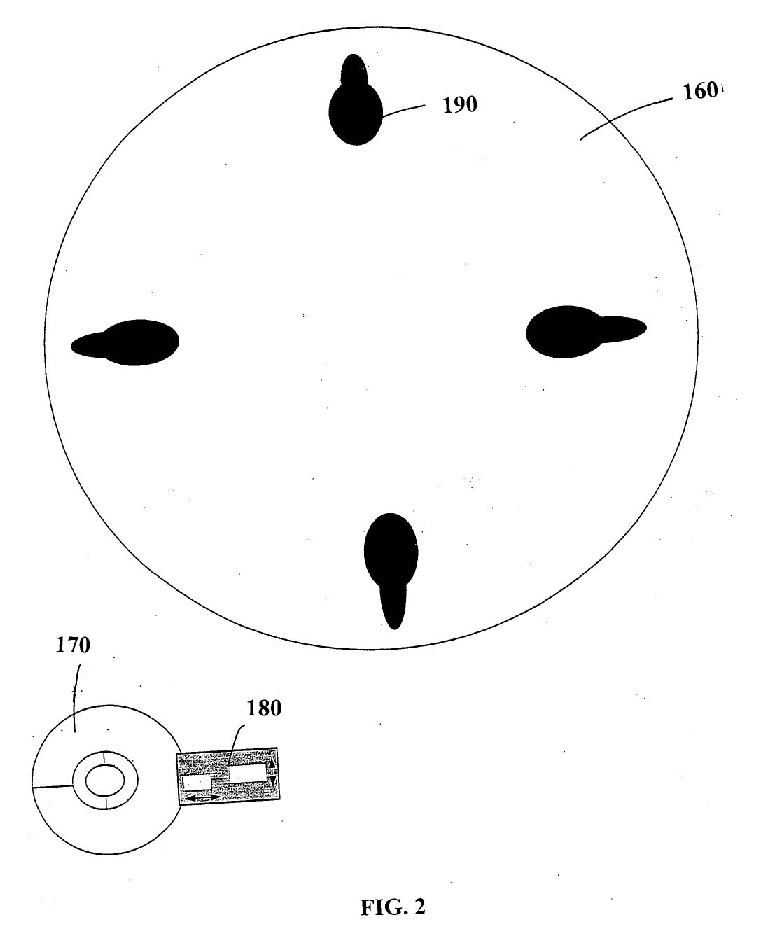

FIG. 2 is a bottom view of a base showing suction cup insertion holes 190 and suction cups 170 with a release handle 180 according to the present invention. Suctions cups 170 detachably attach on an underside of each structure beams 140 of the platform 100.

Referring to FIG. 2, each of the structure beams 140 are enclosed in the bottom base 160 formed with the suction cup insertion holes 190 to receive the suction cups 170. In use, the platform 100 is placed on the roof of the vehicle where the platform 100 is held in place by the suction cups 170. The shape of the bottom base 160 is preferably circular or rectangular. More particularly, the bottom base 160 of the present invention can be made of several different materials that provide slippage protection of the platform 100 from the roof during driving. The bottom base 160 of the invention can be preferably made from a rubber and an elastic material.

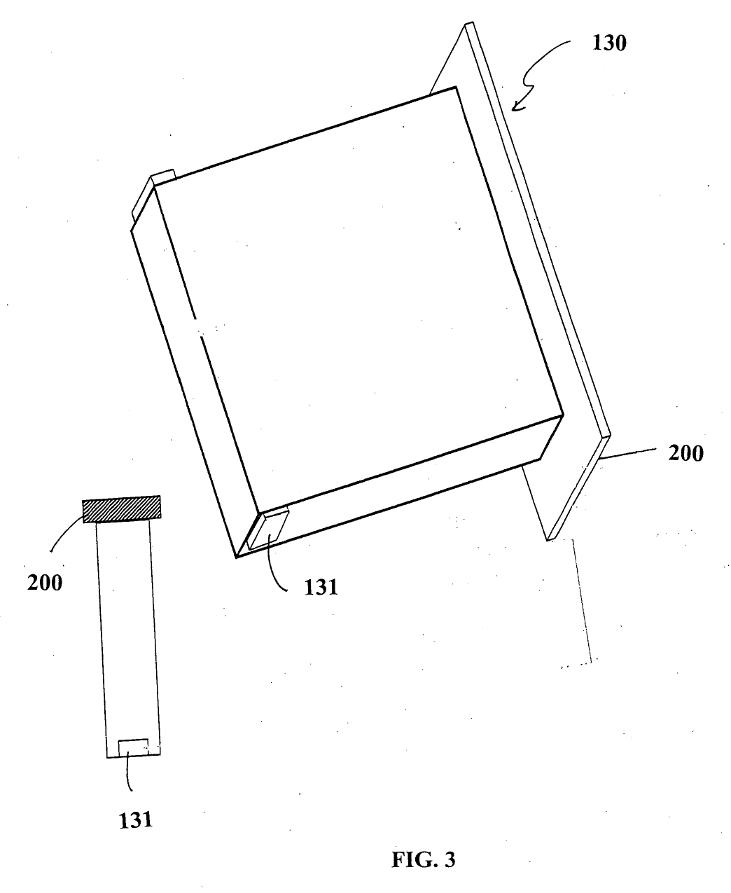

FIG. 3 is a perspective and side view of the slide bar 130 according to the present invention.

As shown in FIG. 3, the sliding bar 130 further includes the slide bar shaft 120 slidably attached to side surfaces of structure beams 140, a slide bar handle 200 attached upon a top surface of the slide bar 130 and a locking pin 131 for permitting the slide bar 120 to be adjustable in the slide bar shaft 120. Straps and tie-down belts are preferably included in the kit for more securing the load. The slide bar 130 is locked at a preferred location by the locking pins 131 used to lock the slide bar 130 in an upper position. Other locking mechanisms are contemplated.

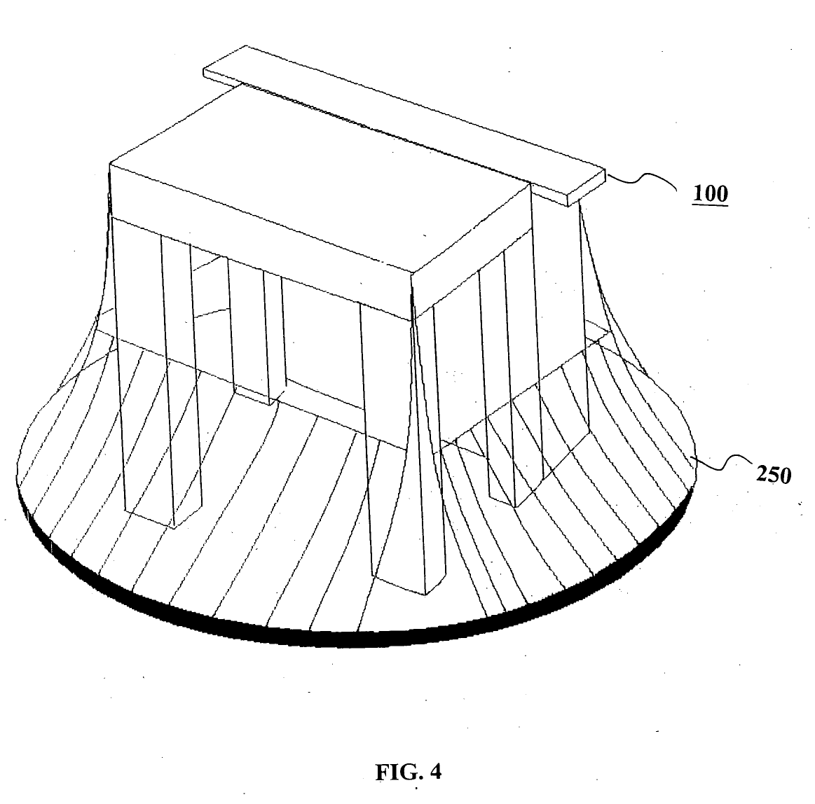

FIG. 4 illustrates a perspective view of outer skin structure of a platform according to the present invention.

Referring to FIG. 4, the outer skin structure 250 of the platform 100 is provided to cover the inner structure of the platform 100, which enables the inner structure of the platform 100 to be protected from the bad weather condition. The outer skin structure 250 of the platform 100 can be form-fitted around the outer surface of the inner structure, or can be an integral part of the inner structure itself.

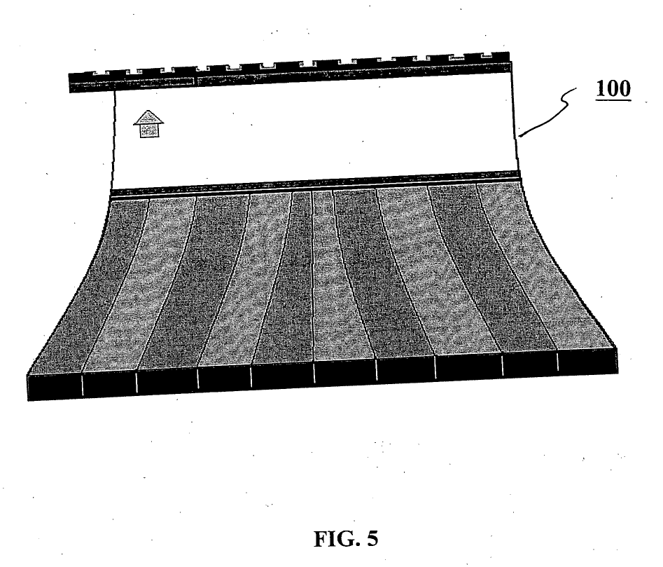

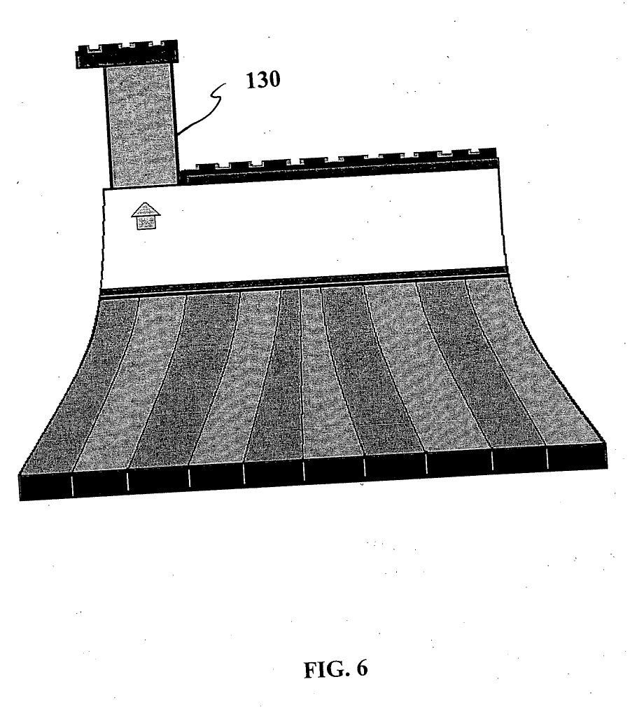

FIG. 5 illustrates a side view of a platform 100 of FIG. 4, and FIG. 6 illustrates a side view of a platform with slide bar 130 raised of FIG. 4. Referring to FIG. 6, if necessary, the sliding bar 130 may be raised depending on the shape or size of the item to better grip the load of the item inside the platform 100.

In place of a slide bar, a lateral supporting element 130 may be provided at the main body for preventing lateral shift of the large item from the modular support platforms. Therefore, FIG. 6 illustrates either the raised slide bar embodiment or the fixed lateral supporting element embodiment of the present invention.

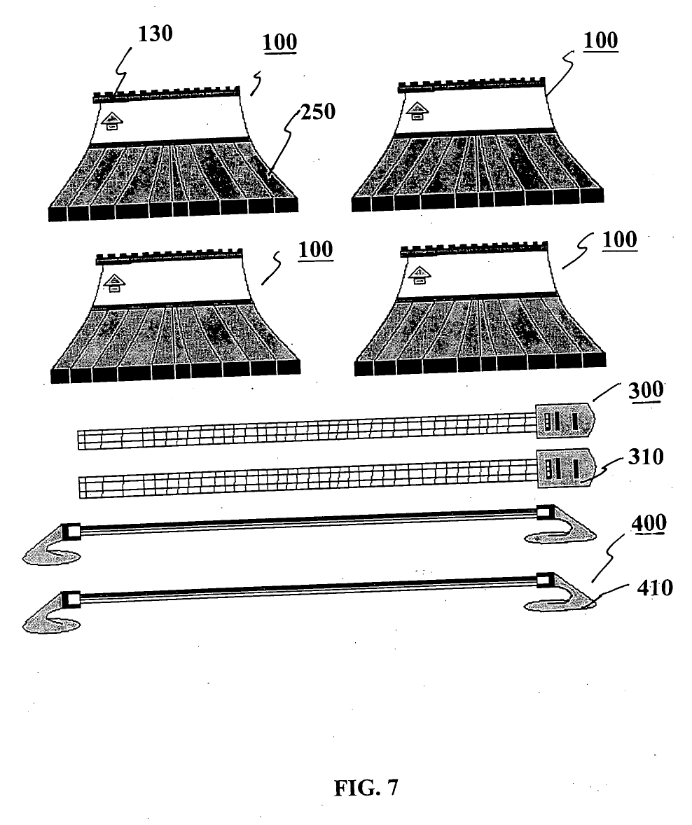

FIG. 7 illustrates a kit for final product having a tie-down belt 300 and a strap 400 according to the present invention.

Referring to FIG. 7, two adjustable belts 300 having a metal belt buckle 310 may wrap the items through the windows of the vehicle and two elastic straps 400 having a plastic strap hook 410 at each end thereof may secure the load of items from bumper to bumper.

The kit of the present invention is shown in FIG. 7 and includes four platforms 100 having a sliding bar 130, an outer skin structure 250, two tie-down belts 300 and two straps 400. The kit can be presented in a self-store package.

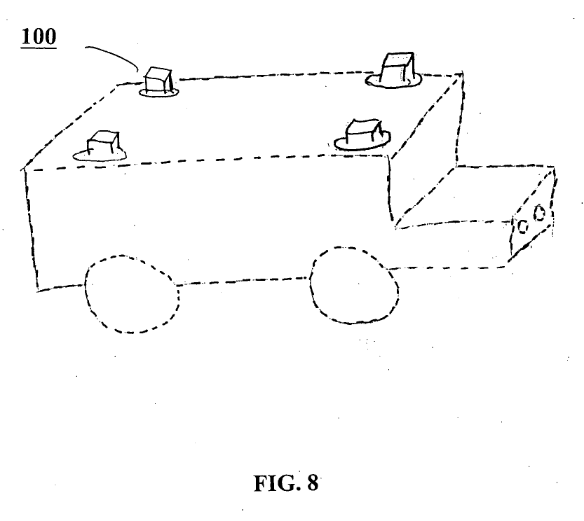

Referring to FIG. 8, a plurality of platforms 100 (four are shown for example purposes) are placed on the roof of the vehicle at any desired location considering the load distribution size and shape of the item to be transported. Then, each structure beam 140 of the platform 100, having detachable suction cups 170 on the underside thereof, is pressed down to make sure the suction cups 170 adhere to the roof of the vehicle so it stays in place. After the platform 100 is secured on the roof, the item can be placed on top of the platforms 100, while making sure the weight of the item evenly distributed among them. In addition, two adjustable belts 300 may wrap the items through the windows of the vehicle and two elastic straps 400 secure the load of items from bumper to bumper.

The steps of disassembling the item are simple such as unbuckling the belts, removing the item from the platform and then pulling upwards the release tabs of the suction cups. After the use, the kit is placed back in the self-store packaging so it can be stored in home or vehicle for future use.

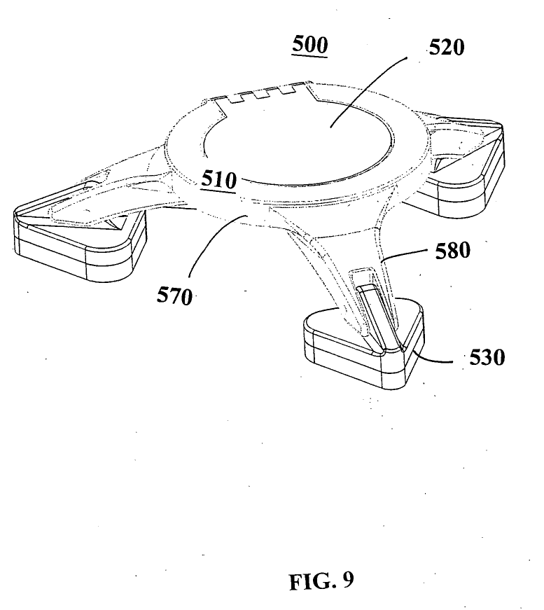

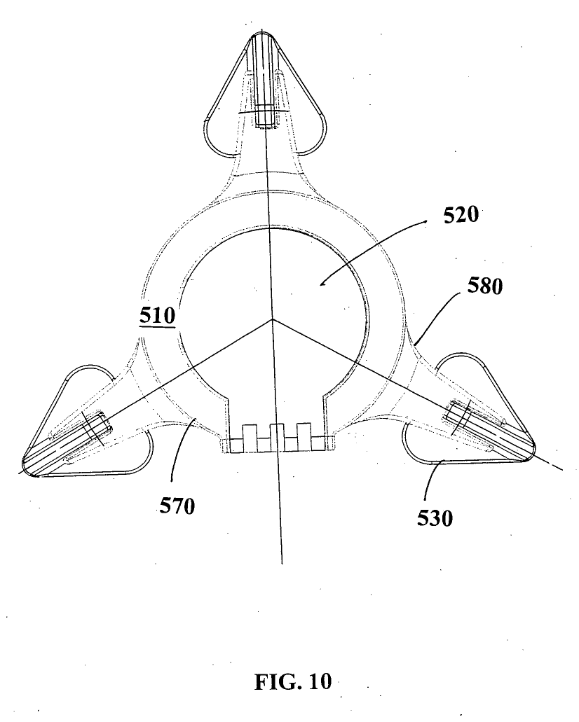

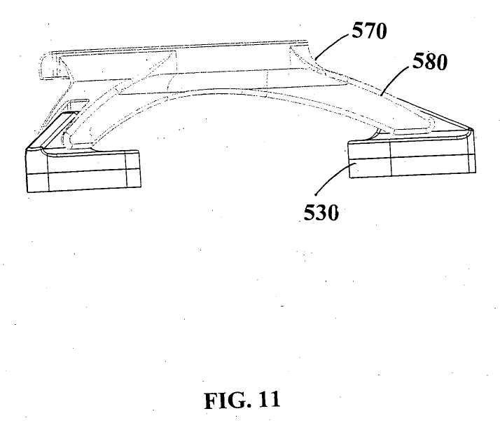

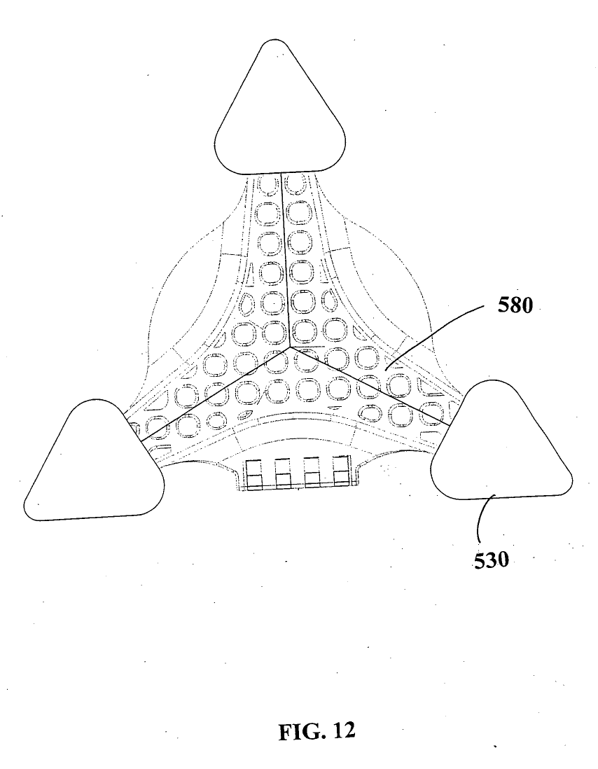

FIGS. 9-14 illustrate a platform according to another embodiment of the present invention.

As shown in FIGS. 9-13, the modular roof platform 500 according to the present invention includes a structural body 510, a brace plate 520 and a plurality of support feet 530.

The structural body 510 according to the present invention includes a main body 570 having a plurality of legs 580. The legs 580 of the structural body 510 extend from the side surface of the main body 570 at a desired length along a circumferential direction with a predetermined tilt angle. The support feet 530 are rotatably coupled at an end of the legs 580 of the structural body 510 with a second hinge pin 550 for stably adhering the platform 500 to the roof of the vehicle so it stays in place.

The brace plate 520 is a lateral supporting element for preventing lateral shift of the large item from the modular support platforms. The brace plate 520 can be rotatable or fixed to the main body 570.

The brace plate 520 is rotatably coupled to one side of the main body 570 with a first hinge pin 540 for brace plate so that the brace plate 520 is opened and closed.

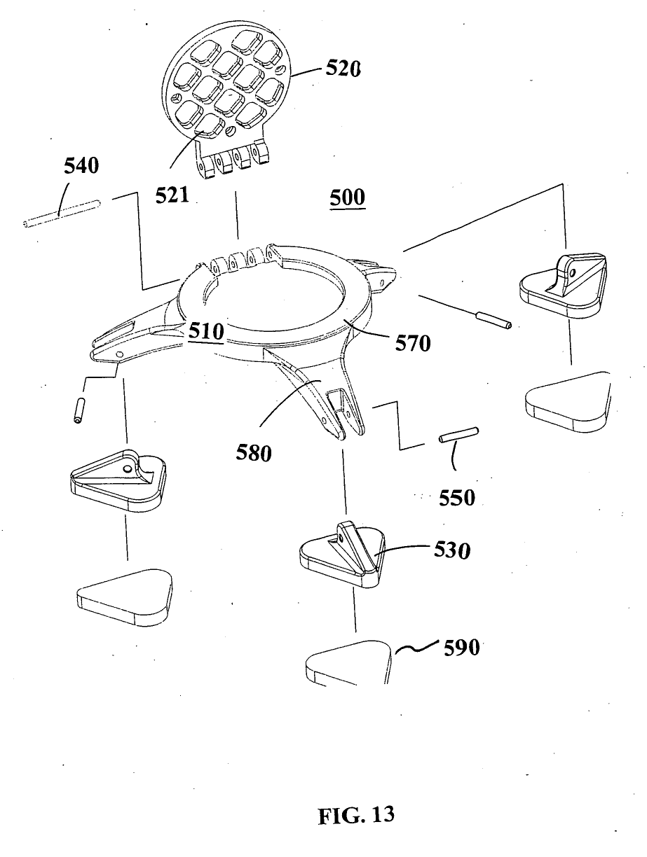

Referring to FIG. 13, the platform 500 further includes a first hinge pin 540 for rotatably coupling the brace plate 520 with main body 570 of the structural body 510, a plurality of second hinge pins 550 for rotatably coupling the end of the legs 580 with the support foot 530. The brace plate 520 has protruding teeth 521 extending from a lower surface of the brace plate 520. The protruding teeth 521 of the brace plate 520 are made of elastic material for providing slippage protection of an item for transporting from the platform 500. Each support foot 530 has a foot pad 590 attached to the bottom surface of the support foot 530. Each foot pad 590 is constructed of a non-slip material that can prevent a lateral shift of the modular roof platform and protect the surface on which the invention is placed. The foot pad 590 has protruding teeth (not shown) extending from a bottom surface. The protruding teeth of the foot pad 590 are made of elastic material for providing slippage protection of the platform 500 from a roof of an automobile.

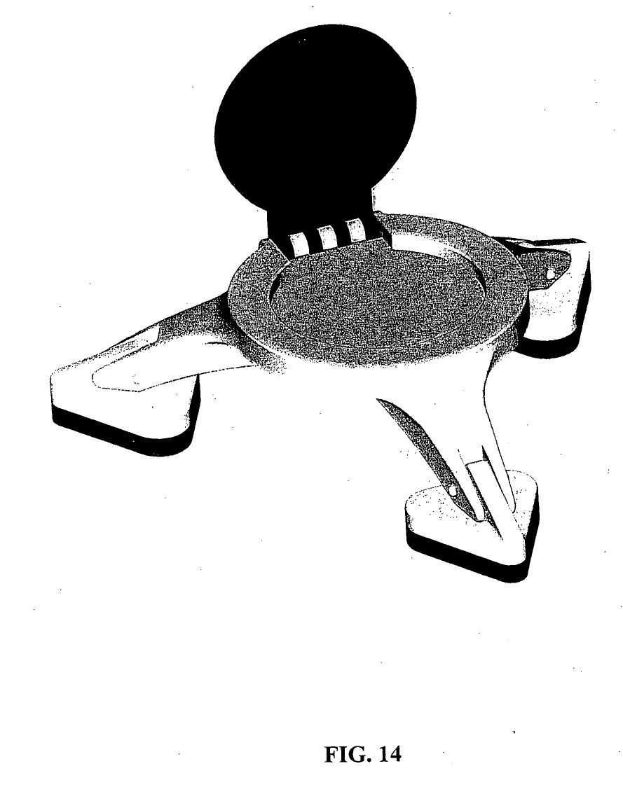

Referring to FIG. 14, the brace plate 520 is rotated in the range of about 0 to 90 degrees with respect to the main body 570 of the structural body 510.

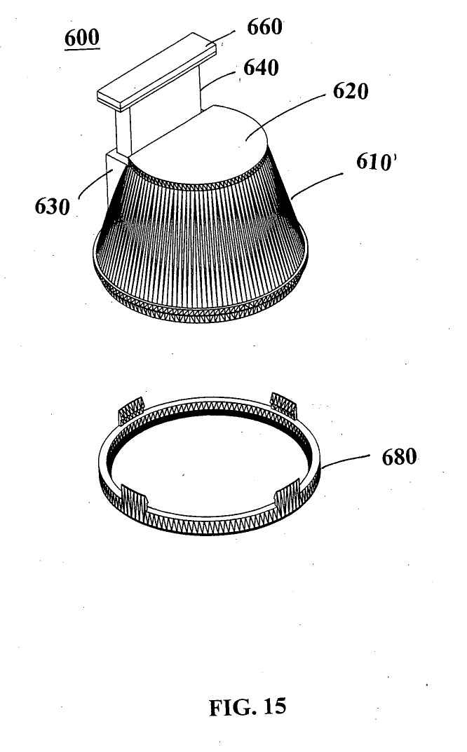

In place of a slide bar, a lateral supporting element 640 may be provided at the main body for preventing lateral shift of the large item from the modular support platforms. Therefore, FIG. 15 illustrates either the raised slide bar embodiment or the fixed lateral supporting element embodiment of the present invention.

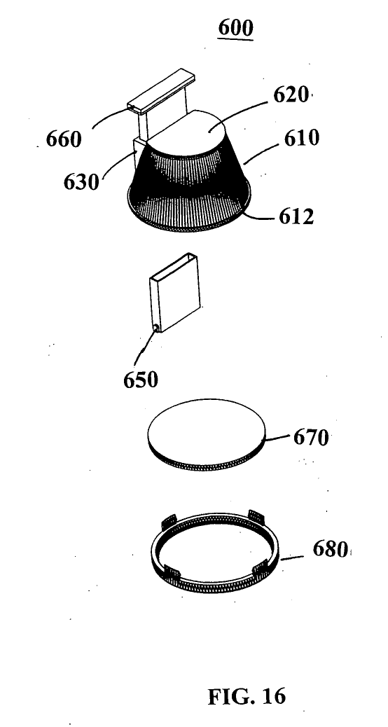

FIGS. 15 and 16 illustrates a platform according to another embodiment of the present invention.

Referring to FIG. 16, a modular roof platform 600 according to the present invention includes a main body 610, a slide bar 640, a top base 620, a bottom base 670 and a protective cap 680.

The main body 610 further includes first and second openings 611, 612 and the slide bar shaft 630 disposed within the main body 610. The main body 610 has substantially conical configuration. The protective cap 680 has a circular cross-sectional shape.

A lateral supporting element 640 provide at the main body 610 for preventing lateral shift of the large item from the modular support platforms. The lateral supporting element 640 can be slidable or fixed to the main body 610.

The lateral support element 640 that is slidable is slidably attached within the slide bar shaft 630 of the main body 610. The top base 620 encloses the first openings 611 of the main body 610. The bottom base 670 encloses the second openings 612 of the main body 610. The platform 600 further includes a protective cap 680 fixed to the second openings 612 of the main body 610. A side surface of the main body 610 is preferably made of outer skin structure.

The lateral support element 640 that is slidable further includes a slide bar handle 660 being attached upon a top surface of the lateral support element 640. The lateral support element 640 further includes a locking pin 650 for permitting the lateral support element 640 to be adjustable to a predetermined height. The slide bar shaft 630 has tracks (not shown) on inner walls thereof for sliding the locking pins 650.

The top base 620 is made of elastic material for providing slippage protection of an item for transporting from the platform 600. The bottom base 670 is made of elastic material for providing slippage protection of the platform 600 from a roof of an automobile.

While the invention has been shown and described with reference to a certain preferred embodiment thereof, it will be understood by those skilled in the art that various changes in form and details may be made therein without departing from the spirit and scope of the invention.

What is claimed is:

1. A modular roof platform system comprising:
a plurality of modular roof platforms, comprising:
a main body;
a lateral supporting element attached to the main body;
a bottom base having suction cup insertion holes; and
a plurality of suction cups detachably attached on an underside of the bottom base.

2. The modular roof platform system in accordance with claim 1, wherein the lateral supporting element is a slide bar slidably attached to side surfaces of the main body.

3. The modular roof platform system in accordance with claim 1, wherein the lateral supporting element is fixed to the main body.

4. The modular roof platform system in accordance with claim 2, wherein the slide bar further comprises a slide bar handle being attached upon a top surface of the slide bar.

5. The modular roof platform system in accordance with claim 2, wherein the slide bar further comprises a locking pin for permitting the slide bar to be adjustable within a predetermined range.

6. The modular roof platform system in accordance with claim 2, wherein the slide bar further comprises a slide bar shaft attached to side surfaces of the main body, the slide bar slidably moving therein.

7. The modular roof platform system in accordance with claim 1, wherein the main body has substantially rectangular configuration with four corners.

8. The modular roof platform system in accordance with claim 1, wherein the structure beams has a rectangular cross-section shape with a predetermined length.

9. The modular roof platform system in accordance with claim 1, wherein the main body and bottom base are integrally manufactured by a plastic molding method.

10. The modular roof platform system in accordance with claim 1, wherein the suction cup further comprises a release handle for releasing the suction cup.

11. The modular roof platform system in accordance with claim 1, wherein the bottom base is circular-shaped.

12. The modular roof platform system in accordance with claim 1, wherein the bottom base is made of elastic material for providing slippage protection of the platform from a roof of an automobile.

13. A modular roof platform system comprising:
a plurality of modular roof platforms, comprising:
a structural body having a main body and a plurality of legs, the legs extended from the main body along a circumferential direction with a predetermined tilt angle;
a brace plate attached to the structural body; and
a plurality of support feet rotatalby coupled to an end of each leg of the structural body.

14. The modular roof platform system in accordance with claim 13, wherein the brace plate is rotatably coupled to one side of the structural body.

15. The modular roof platform system in accordance with claim 13, wherein the brace plate is fixed on the structural body for preventing lateral shift of an item from the structural body.

16. The modular roof platform system in accordance with claim 14, wherein the brace plate is rotated in the range of about 0 to 90 degrees with respect to the main body.

17. The modular roof platform system in accordance with claim 14, further comprising:
a first hinge pin for rotatably coupling the brace plate with main body of the structural body;and
a plurality of second hinge pins for rotatably coupling the end of the legs with the support feet.

18. The modular roof platform system in accordance with claim 13, wherein the brace plate has protruding teeth extending from a lower surface of the brace plate.

19. The modular roof platform system in accordance with claim 13, wherein the support foot has protruding teeth extending from a bottom surface of the support foot.

20. The modular roof platform system in accordance with claim 18, wherein the protruding teeth of the brace plate are made of elastic material for providing slippage protection of an item for transporting from the platform.

21. The modular roof platform system in accordance with claim 19, wherein the protruding teeth of the support foot are made of elastic material for providing slippage protection of the platform from a roof of an automobile.

22. A modular roof platform system comprising:
a plurality of modular roof platforms, comprising:
a main body having first and second openings, and a slide bar shaft, the slide bar shaft disposed within the main body;
a lateral supporting element attached to the main body;
a top base enclosing the first openings of the main body;
a bottom base enclosing the second openings of the main body; and
a protective cap fixed to the second openings of the main body.

23. The modular roof platform system in accordance with claim 22, wherein the lateral supporting element is a slide bar slidably attached to side surfaces of the structure beams.

24. The modular roof platform system in accordance with claim 22, wherein the lateral supporting element is fixed to the main body.

25. The modular roof platform system in accordance with claim 23, wherein the slide bar further comprises a slide bar handle being attached upon a top surface of the slide bar.

26. The modular roof platform system in accordance with claim 23, wherein the slide bar further comprises a locking pin for permitting the slide bar to be adjustable within a predetermined range.

27. The modular roof platform system in accordance with claim 22, wherein the main body has substantially conical configuration.

28. The modular roof platform system in accordance with claim 22, wherein the protective cap has a circular cross-sectional shape.

29. The modular roof platform system in accordance with claim 22, wherein the top base is made of elastic material for providing slippage protection of an item for transporting from the platform.

30. The modular roof platform system in accordance with claim 22, wherein the bottom base is made of elastic material for providing slippage protection of the platform from a roof of an automobile.
